(19) United States
(12) Patent Application Publication
(10) Pub. No.: US 2017/0009926 A1
(43) Pub. Date: Jan. 12, 2017

(54) HEATED HOSE AND METHOD

(71) Applicant: PARKER-HANNIFIN CORPORATION, Cleveland, OH (US)

(72) Inventors: Nicholas Marucci, Ravenna, OH (US); Ty Henry, Atwater, OH (US); David Amos, South Euclid, OH (US); William Tasker, Ravenna, OH (US); Michael Swails, Painesville, OH (US); Anthony Maynard, Canton, OH (US); Matthew Peter, Hudson, OH (US)

(21) Appl. No.: 15/115,101

(22) PCT Filed: Feb. 12, 2015
(86) PCT No.: PCT/US2015/015541

§ 371 Date: Jul. 28, 2016

Related U.S. Application Data
(60) Provisional application No. 61/939,779, filed on Feb. 14, 2014.

(51) Int. Cl. F16L 53/00; H05B 3/58; H05B 1/02

(52) U.S. Cl. CPC F16L 53/008; H05B 1/02; H05B 3/58

(57) ABSTRACT

A heated hose assembly (10) includes a tubular member (12), a heater device (14) having an electrical resistance element (18) in thermal communication with the tubular member (12), and a thermal regulating device (30) that controls a flow of electrical current through the heater device (14) based on a sensed temperature of the hose assembly (10). Heat generated by the heater device (14) when the electrical current flows through the resistance element (18) heats the tubular member (12) to prevent or minimize condensation of gases, or coagulation or freezing of liquids, within the tubular member (12) at relatively low ambient temperatures. A method for controlling a heated hose assembly (10) includes providing the referenced tubular member (12), heater device (14), and thermal regulating device (30), and controlling a flow of current through the heater device (14) based on a sensed hose assembly temperature, wherein heat generated by the heater device (14) when the electrical current flows through the heater device (14) heats the tubular member (12).

### RELATED APPLICATION DATA

This application claims priority to U.S. Provisional Patent Application Ser. No. 61/939,779, filed on Feb. 14, 2014, the content of which is incorporated here by reference.

### FIELD OF INVENTION

This invention relates generally to a heated hose assembly, and more specifically relates to an electrically heated hose that prevents or minimizes condensation of gases or coagulation or freezing of liquids within the hose assembly at relatively low ambient temperatures.

### BACKGROUND OF THE INVENTION

Hoses convey liquids and gases between spaced locations. The term “hose” refers to any generally tubular, elongated member or device and includes flexible, semi-flexible and rigid devices commonly referred to as “hoses,” “tubes,” “pipes” and the like. Hoses may have different cross-sections, and may have for example, round, oval, polygonal or other cross sectional shape. Hoses may be of any material, including, for example, thermosetting, thermoplastic, metallic and non-metallic materials. Hoses may be single wall, multiple wall, reinforced or non-reinforced, and may include end fittings or no end fittings.

When hoses are used to convey liquids and gases in environments with ambient temperatures that change over time, it may be desirable to prevent or minimize condensation of gases, or coagulation or freezing of liquids, within the hose at relatively low ambient temperatures. Such applications include prime mover engine applications, such as, for example, transportation vehicles (including, automobiles, trucks, buses, trains, aircraft, refrigeration trailers and the like), construction vehicles, farm equipment, mining equipment, and stationary equipment such as diesel engine driven electric generators. In these and other applications, hoses are exposed to ambient temperatures that change over a wide range. Hoses in such applications may be used for a wide variety of purposes, including for example, conveying gases or liquids in engine crankcase ventilation systems, fuel systems, hydraulic systems, pneumatic systems, coolant systems, refrigerants, emulsions, slurries, selective catalytic reduction systems, and others.

Various conventional systems have been developed to provide for heated hoses to prevent or minimize condensation of gases, or coagulation or freezing of liquids. Conventional configurations typically require applying heat from a heat source to the hose material. Although conventional systems provide adequate heat, such systems have proven to be inefficiently regulated. In particular, conventional hose heating systems typically have been provided as an after-market item, and thus are turned on essentially manually based on user considerations of ambient temperature. The heating systems thereafter further tend to run continuously until turned off manually or by a timer, but such continuous usage may not be necessary based on local temperature as it changes over time within or adjacent the pertinent portion of the hose. Inefficient regulation has resulted in poor power consumption characteristics and overly expensive operation.

### SUMMARY OF THE INVENTION

The present invention provides a self-regulating heated hose assembly and a related method of controlling such a heated hose assembly. The hose assembly may be straight or formed into any suitable shape. The hose assembly may include a tubular member (i.e., hose) and an associated heater device. The heater device, such as for example an electrical resistance device, may be provided in thermal communication with the tubular member. The heater device may be embedded on or within the wall of the tubular member itself, or be provided as a wrapped adhesion bonded or extruded device that extends along or around the inner or outer peripheral surface of the tubular member. The hose assembly includes a thermal regulating device, such as a thermostat, positive or negative temperature coefficient device, or the like that controls the amount of heat transferred from the heater device to the tubular member to heat gas or liquid carried by the tubular member in proportion to the ambient temperature of the hose assembly or the medium in which the assembly is located. This thermal regulating device may be located within, on, near or remote from the tubular member, and may be used to control one or more heated hose assemblies and/or heater device circuits.

In this manner, the heated hose assembly of the present invention is a self-regulating device that is self-initiating and thereafter responsive to local conditions, thereby providing more efficient and precise control. The result is more efficient power consumption characteristics.

An aspect of the invention, therefore, is a heated hose assembly. In exemplary embodiments, the heated hose assembly includes a tubular member (e.g., any suitable hose or hose-like member), a heater device having an electrical resistance element in thermal communication with the tubular member, and a thermal regulating device (e.g., a thermostat) that controls a flow of electrical current through the heater device based on a sensed temperature of the hose assembly. Heat generated by the heater device when the electrical current flows through the resistance element heats the tubular member to prevent or minimize condensation of gases, or coagulation or freezing of liquids, within the tubular member at relatively low ambient temperatures.

Another aspect of the invention is a method for controlling a heated hose assembly. In exemplary embodiments, the control method includes the steps of providing the referenced tubular member, heater device, and thermal regulating device, and controlling a flow of current through the heater device based on a sensed hose assembly temperature. Heat generated by the heater device when the electrical current flows through the heater device heats the tubular member to prevent or minimize condensation of gases, or coagulation or freezing of liquids, within the tubular member at relatively low ambient temperatures.

In exemplary embodiments of the heated hose assembly and related control method, when the thermal regulating device senses that the hose assembly temperature falls below a first predetermined threshold temperature, the thermal regulating device controls the heater device to permit the flow of current through the heater device. When the temperature sensor of the thermal regulating device senses that the hose assembly temperature rises above a second predetermined threshold temperature, the thermal regulating device controls the heater device to stop the flow of current through the heater device. The second predetermined threshold temperature may be the same as the first predetermined temperature, or alternatively the second predetermined threshold temperature may be above the first predetermined threshold temperature. The first and second predetermined threshold temperatures may be an ambient environmental temperature adjacent the hose assembly, or a sensed temperature of the tubular member itself.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto. Features that are described and/or illustrated with respect to one embodiment may be used in the same way or in a similar way in one or more other embodiments and/or in combination with or instead of the features of the other embodiments.

### BRIEF DESCRIPTION OF THE DRAWINGS

FIG. 1 is a drawing depicting a plan view of an exemplary heated hose assembly in accordance with embodiments of the present invention.

FIG. 2 is a drawing depicting a perspective view of an exemplary thermostat for use in accordance with embodiments of the present invention.

FIG. 3 is a drawing depicting a plan view of a second exemplary heated hose assembly in accordance with embodiments of the present invention.

FIG. 4 is a drawing depicting a plan view of a third exemplary heated hose assembly in accordance with embodiments of the present invention.

FIG. 5 is a drawing depicting a plan view of a fourth exemplary heated hose assembly in accordance with embodiments of the present invention.

### DETAILED DESCRIPTION

Embodiments of the present invention will now be described with reference to the drawings, wherein like reference numerals are used to refer to like elements throughout. It will be understood that the figures are not necessarily to scale.

As aspect of the invention is a heated hose assembly. As further detailed below, in exemplary embodiments the heated hose assembly includes a tubular member (i.e., any suitable hose or like member), a heater device having an electrical resistance element in thermal communication with the tubular member, and a thermal regulating device (e.g., a thermostat) that controls a flow of electrical current through the heater device based on a sensed temperature of the hose assembly. The heat generated by the heater device when the electrical current flows through the resistance element heats the tubular member.

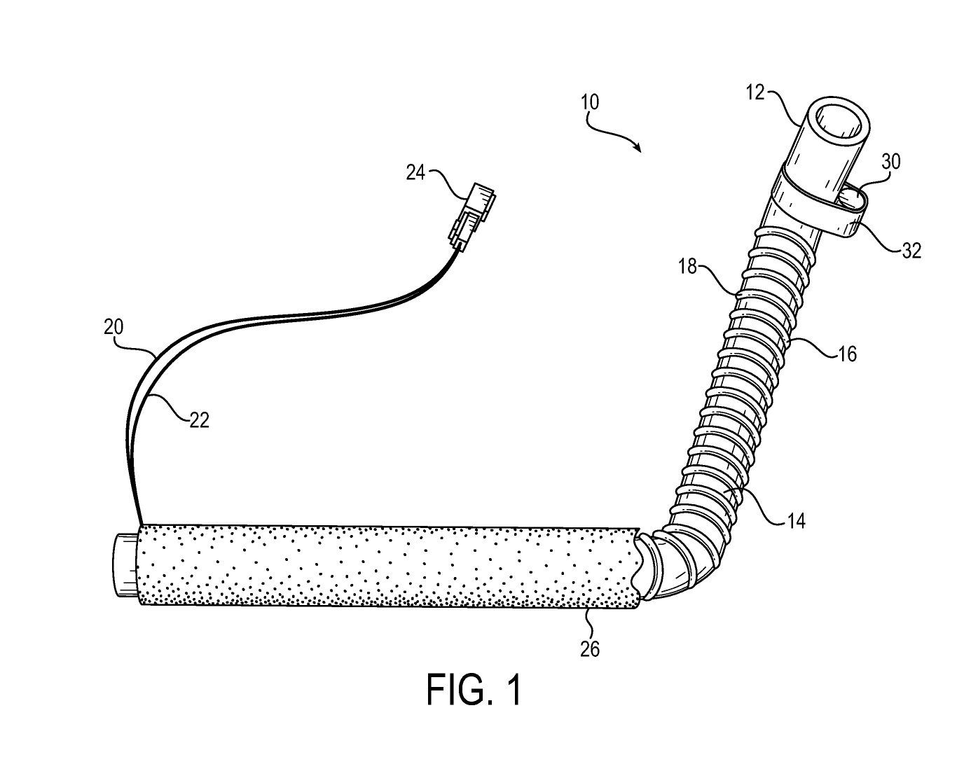

FIG. 1 is a drawing depicting a plan view of an exemplary heated hose assembly 10 in accordance with embodiments of the present invention. The heated hose assembly 10 includes an elongated inner tubular member 12. The term “tubular member” is used herein as broadly encompassing components commonly referred to as hoses and like devices, including portions thereof. As referenced above, such tubular members and like hose devices may include flexible, semi-flexible and rigid devices commonly referred to as “hoses,” “tubes,” “pipes”, “pipe sections” and the like. The tubular member 12 may have a cross-section of any suitable shape, such as for example, round, oval, polygonal or other cross sectional shape. The tubular member 12 may be made of any suitable material as are know in the art, including for example, thermosetting, thermoplastic, metallic and non-metallic materials. The tubular member may be single wall, multiple wall, reinforced or non-reinforced, and may include end fittings or no end fittings. The tubular member further may be straight or configured into any suitable shape with bends or turns.

The tubular member 12 is configured and located to be in thermal communication with a heater device 14. As seen in the example of FIG. 1, the heater device 14 may be located around an outer diameter of the tubular member 12 along an axial length of the tubular member. Alternatively, the heater device may be embedded within the material of the tubular member itself, or located on an inner diameter of the tubular member. Further in the example of FIG. 1, the heater device 14 may be a flexible heater device that conforms to an outer diameter of the tubular member, and thus can be made of any suitable shape as may be commensurate with the shape of the tubular member.

The heater device 14 may be an elongated and corrugated member with corrugations 16 so as to provide requisite flexibility to the heater device to permit a flex-fit interaction to secure the heater device 14 onto the tubular member 12. The heater device may include a resistance element 18. For example, the resistance element 18 may comprise heater wires in the corrugations of the heater device that generate heat of resistance from electrical conduction through the heater wires. The heater wires may extend and spiral along the entire length of the heater device 14, thereby extending around the portion of the tubular member 12 to be heated. In this manner, the heater wires may be located in thermal communication with the tubular member 12 in a spiral configuration within the corrugations of the heater device, but other configurations may be employed. For example, the heater wires may be arranged in axial or spiral/axial combinations, or alternatively the heater wires can be arranged in a straight and longitudinal configuration. Any suitable configuration may be employed.

Electrical current may be provided to the heater wires of the heater device 14 via lead wires 20 and 22. The lead wires 20 and 22 may be coated with an insulation material, such as for example silicone, as is conventional. The lead wires 20 and 22 further may be connected to an electrical connector 24, which in turn may be connected ultimately to an electrical power source (not shown) that provides the electrical current for the heater device.

The heated hose assembly 10 further may include a jacket 26, which is shown in cut-away fashion in FIG. 1. In actual operation, the jacket 26 may extend over the entirety of the heater device 14 and portion of the tubular member 12 to be heated. The jacket 26 may be a woven fabric sleeve of heat insulating material that retains heat generated by the heater device 14 adjacent to the tubular member 12, and further protects the heater device against abrasion or other mechanical damage.

As referenced above, the heated hose assembly 10 is a self-regulating assembly by which heat is generated in response to ambient conditions associated with the tubular member 12. To operate in a such a self-regulating fashion, the heated hose assembly 10 further may include a thermal regulating device 30. In exemplary embodiments, the thermal regulating device may be a thermostat that controls the flow of current through the heater device. The thermostat as is typical may include appropriate temperature sensor elements for sensing ambient temperatures associated with the tubular member 12. For example, the thermostat 30 may sense the ambient environmental temperature around the hose assembly, or may have sensor elements that are near or in contact with the tubular member for sensing the temperature of or adjacent to the tubular member itself.

The thermostat 30 further may include control circuitry for controlling the flow of current through heater device 14. For example, when a temperature sensor of the thermostat 30 senses that a hose assembly temperature (e.g., ambient temperature adjacent the hose assembly or a sensed temperature of the tubular member itself) falls below a first predetermined threshold temperature, the control circuitry operates to close the circuit of the heater device 14 to permit the flow of current through the heater device, and particularly through the resistance wires 18. Heat of resistance is thereby generated in the vicinity of the tubular member to prevent or minimize condensation of gases, or coagulation or freezing of liquids, within the tubular member at relatively low ambient temperatures below the first predetermined threshold temperature. To enhance efficiency, the generated heat is better contained adjacent the tubular member by the presence of the jacket 26 of insulating material. When the temperature sensor of the thermostat 30 senses that the hose assembly temperature rises above a second predetermined threshold temperature, the control circuitry operates to open the circuit of heater device 14 to stop the flow of current through the heater device. In exemplary embodiments, the second predetermined threshold temperature may be the same as the first predetermined threshold temperature. Alternatively, the second predetermined threshold temperature may be above the first predetermined threshold temperature to provide some overshoot or clearance in the restarting of the flow of current through the heater device. The first and second threshold temperatures may be varied and set to any suitable temperatures as warranted based on any particular application, environmental conditions, and/or the fluid (gas or liquid) that is to flow through the heated hose assembly 10.

In accordance with the above structural configuration of a heat hose assembly 10, another aspect of the invention is a method of controlling a heated hose assembly. The control method may include the steps of: providing a length of a tubular member, which may be formed or straight and be of any predetermined suitable shape; extending a heater device, such as for example an electrical resistance heater device including heater wires around an outer diameter of the tubular member along an axial length of the tubular member, which may extend along substantially an entire length of the tubular member, or alternatively only along such portion of the tubular member that is exposed to low temperatures that could cause condensation, coagulation or freezing of a fluid flowing through the tubular member; applying an insulating jacket at locations along the tubular member to contain heat adjacent to the tubular member; and connecting a thermal regulating device to the heater device and controlling a flow of current through the heater device based on a sensed hose assembly temperature; wherein heat generated by the heater device when the electrical current flows through the heater device heats the tubular member.

In exemplary embodiments, the control method further may include the steps of: when the thermal regulating device senses that the hose assembly temperature falls below a first predetermined threshold temperature, controlling the heater device to permit the flow of current through the heater device; and when the temperature sensor of the thermal regulating device senses that the hose assembly temperature rises above a second predetermined threshold temperature, controlling the heater device to stop the flow of current through the heater device. The second predetermined threshold temperature may be the same as the first predetermined temperature, or alternatively the second predetermined threshold temperature may be above the first predetermined threshold temperature. The first and second predetermined threshold temperatures may be an ambient environmental temperature adjacent the hose assembly, or a sensed temperature of the tubular member itself.

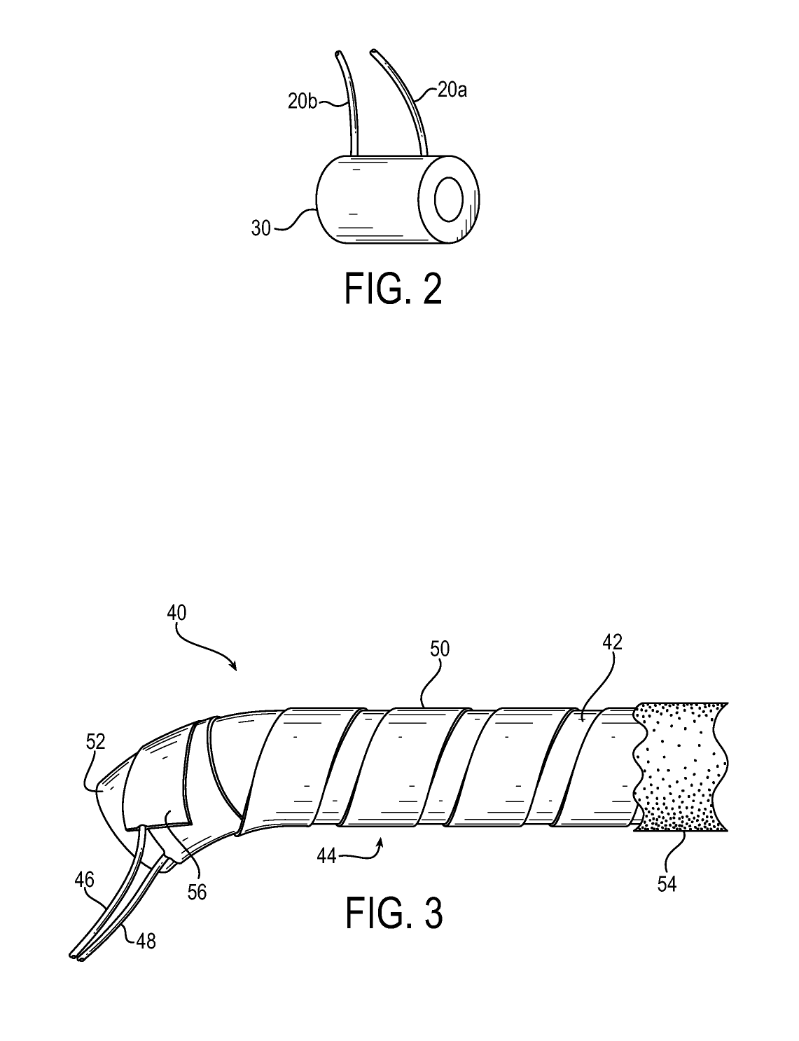

In the example of FIG. 1, the thermostat 30 is mounted on an end of the heater device and tubular member with a clamp or other suitable mounting element 32, opposite to the location of entry of the lead wires into the heater device. Any suitable configurations relative to placement of the thermostat 30 may be employed. FIG. 2 is a drawing depicting a perspective view of an exemplary thermostat 30 for use in accordance with embodiments of the present invention. In this example, the thermostat 30 is a bimetallic disc thermostat that is attached in series to at least one of one of the lead wires 20 (or 22) between lead wire elements 20a and 20b. The thermostat in turn may be mounted on and carried by the heater device 14 or tubular member 12, but any suitable thermostat location may be employed. Generally, the thermostat may be located within, on, near or remote from the tubular member, provided that adequate temperature sensing and control may be performed at the thermostat's location. In addition, although only one hose assembly and heater device are depicted in the example of FIG. 1, the thermostat may be used to control one or more heated hose assemblies and/or one or more heater device circuits.

FIGS. 3-5 are drawings depicting plan views of various additional exemplary embodiments of heated hose assemblies in accordance with embodiments of the present invention. The variations in FIGS. 3-5 pertain largely to the heater device and associated features of the tubular member and jacket. It will be appreciated that a thermal regulating device, such as the thermal regulating device or thermostat 30 of FIGS. 1 and 2, may be employed for heat regulation in any of the embodiments of FIGS. 3-5.

FIG. 3 depicts an exemplary embodiment of a heated hose assembly 40. The heated hose assembly 40 includes an inner tubular member 42 comparably as in the previous embodiment. The heated hose assembly 40 further may include a heater device 44 secured to the tubular member by a suitable fixing element. In the example embodiment of FIG. 3, the heater device 44 may be a generally flat, elongated heat tape, the tape acting as the fixing element and having resistance or heater wires embedded within the heat tape. Lead wires 46 and 48 may be mechanically and electrically connected to the resistance or heater wires to carry electrical current. The heater wires of heater device 44 may extend along the entire length of the heat tape, and a woven fabric 50 may be provided to cover and encapsulate the heater wires. The woven fabric 50 may terminate near one axial end 52 of the tubular member 42, and the heater wires extend from the termination of the woven fabric 50. An insulating jacket 54 may be provided to cover and insulate the heater device 44 comparably as in the previous embodiment. An end tape 56 may be provided to secure the end of the woven fabric of the 50 of the heater device 42 to prevent unraveling or movement of the heater wires from a desired location. As referenced above, a thermal regulating device, such as the thermostat 30 of FIGS. 1 and 2, may be provided in the embodiment of FIG. 3 for controlling current flow through the heater device 44 based on a hose assembly temperature in the manner described above.

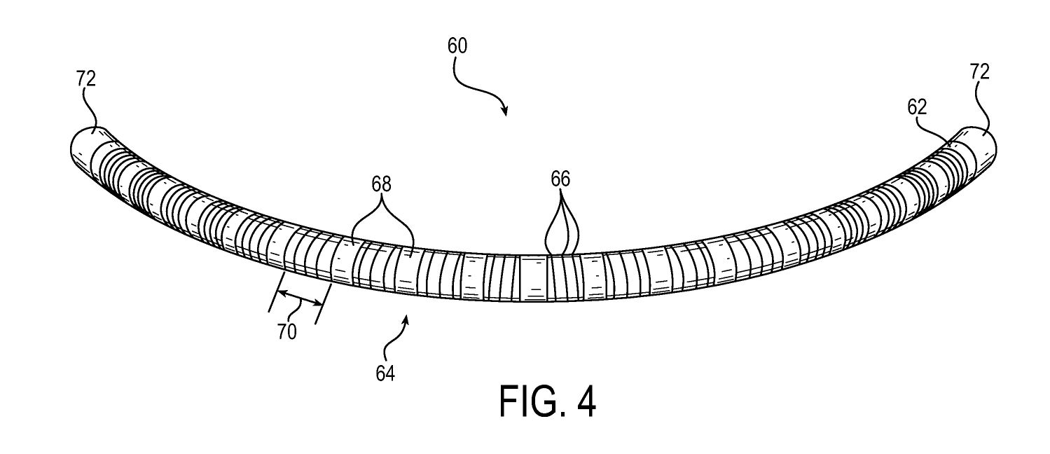

FIG. 4 depicts an exemplary embodiment of a heated hose assembly 60. The heated hose assembly 60 includes an inner tubular member 62 comparably as in the previous embodiments. The heated hose assembly 60 further may include a heater device 64 secured to the tubular member by a suitable fixing element. In the example embodiment of FIG. 4, the heater device 64 may incorporate heater wires 66 that are spirally wrapped around the tubular member 62. Adhesive tape 68 may act as the fixing element, being applied to the heater wires and the tubular member to retain the heater wires in a fixed position against the tubular member. The adhesive tape 68 may be applied to the ends of tubular member 62 to prevent unraveling and movement of the heater wires 66, and the adhesive tape 66 further may be applied at regularly spaced intervals along the tubular member 62 to retain the heater wires 66 in a fixed position, with adjacent spiral wraps being spaced a predetermined distance 70 apart. End fittings 72 also may be attached to the ends of the hose. As referenced above, a thermal regulating device, such as the thermostat 30 of FIGS. 1 and 2, may be provided in the embodiment of FIG. 4 for controlling current flow through the heater device 64 based on hose assembly temperature in the manner described above.

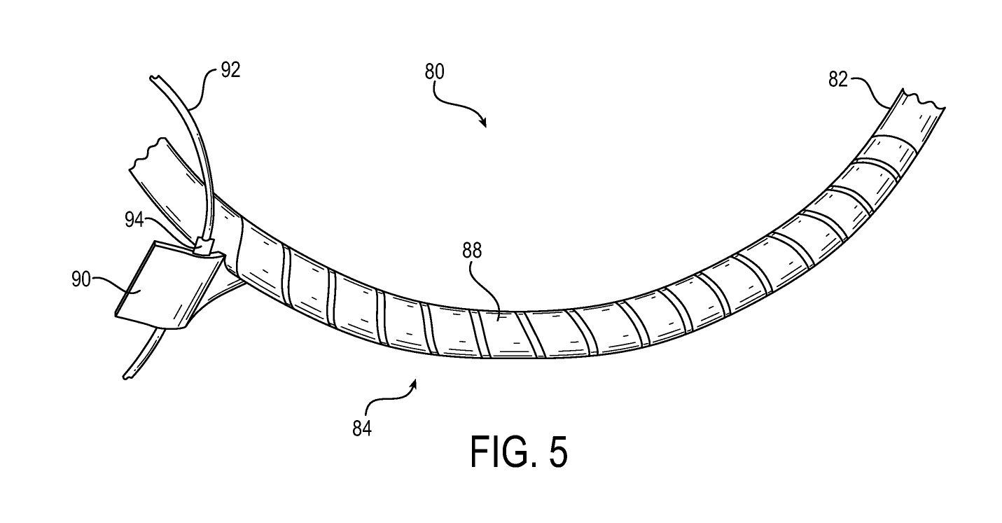

FIG. 5 depicts an exemplary embodiment of a heated hose assembly 80. The heated hose assembly 80 includes an inner tubular member 82 comparably as in the previous embodiments. The heated hose assembly 80 further may include a heater device 84 secured to the tubular member by a suitable fixing element. In the example embodiment of FIG. 5, the heater device 84 includes heater wires embedded within a woven fabric 88. The woven fabric containing the heater wires may be pre-formed in a spiral configuration to provide a stretch to lengthen or shrink to a stretch-fit engagement, the stretch-fit engagement acting as the fixing element with an exterior surface of the tubular member 82. A mechanical connection 90 embedded within an end of the woven fabric may connect the heater device to a support element 92. As seen in the example of FIG. 5, the support element 92 may include an electrical connector 94 containing wire connections for connecting the heater device 84 to the electrical power source (not shown). As referenced above, a thermal regulating device, such as the thermostat 30 of FIGS. 1 and 2, may be provided in the embodiment of FIG. 5 for controlling current flow through the heater device 84 based on hose assembly temperature in the manner described above.

In the exemplary embodiments depicted in FIGS. 1-5, the heater device is disposed on a tubular member of predetermined semi-rigid fixed shape, and utilizes a thermal regulating device (thermostat) to self-regulate the amount of heat provided by the heater device. In exemplary embodiments, the heater device may be applied to the tubular member during manufacturing of the tubular member and before forming the tubular member into a predetermined fixed shape, such as for example, by spiral winding or braiding, co-extruding or otherwise applying the heater device to the tubular member as the tubular member longitudinally passes a manufacturing station. In such exemplary embodiments, the heater device may be disposed on an interior surface or on an exterior surface of the tubular member, or intermediate the interior and exterior surfaces of the tubular member.

In further exemplary embodiments, the thermal regulating device may be positive or negative temperature coefficient resistance material or wire, or a device that self-regulates the power consumption and heat produced in proportion to ambient temperature. In such embodiments, the thermal regulating device is incorporated as part of the heater device, so a separate or distinct thermostat or like element may be eliminated. The heated hose assembly may also be manufactured without a thermostat and either controlled by a controller as supplied within an OEM system, which likewise obviates the need for control by a separate or distinct thermostat or like device.

In the exemplary embodiments described above, the heater device, such as resistance wires or heater strips, are applied to an external surface of the tubular member to prevent fluid from condensing or freezing internally to the tubular member. A thermostat can be chosen and configured based on a user's specific requirements for temperature range. The heated hose assembly may be used in any cold weather application. Such applications may include, for example, on and off highway transportation vehicles, crank case ventilation hoses, pipe lines, construction equipment, oil lines, farming equipment, water lines, generators, and any other industrial application where it may be necessary to heat a fluid line. The heated hose assembly may transport any suitable fluid that may require heating, such as air, other gasses, oil, water, coolant, transmission fluid, steering fluid, brake fluid, and the like.

The hoses, pipes, and other tubular members that require heating may be constructed of any material capable of withstanding cold temperatures seen in cold environments (for example, down to −40° C.), and also are capable of withstanding the higher temperatures given off by the heater device. Suitable materials of the tubular member may include, but are not limited to, polyamide plastic, EPDM rubber, fluoropolymers, or braided/solid steel, any of which may or may not be reinforced.

The hoses, pipes, and other tubular members may be pre-formed, straight, coiled, or positioned and shaped custom per the user's application. The heater devices providing the freeze protection of these tubular members may include any suitable resistance element, including resistance wire, stamped plating, insulated strips, or coiled strips, as well as positive temperature coefficient, self-regulating materials, and the like. The lie or orientation of the heater device may be placed linearly, joggled, helical, or concentric in reference to the tubular member, and can be placed internally, externally, or within an insulating material.

As referenced above, the heater device may be jacketed or covered to provide adhesion, insulation, and protection from wear. The jacket may be made of any suitable material, such as for example, silicone tape, self-amalgamating tape, electrical tape, extrusion grade jacket material, adhesive strips, hose clamps, fibrous or woven insulation materials of single or multiple layers, or any other form of suitable insulating material.

The overall design of heated hose assembly may be broadly customized per a user's specifications and requirements. A build of the heated hose assembly may include a stretch-to-design configuration using different resistance wires or strips. This design may be based on power and heat requirements. When the heated hose assembly is designed with thermostats, the thermostats may be configured directly with a specific range of temperature settings, or can be adjustable through a fixed variable switch, or have completely programmable variable settings using a thermocouple. The thermostat can be connected in series so that the power to the heater device is regulated between two predetermined temperature settings (see, e.g., FIG. 2). Because the thermostat is spliced directly in series with the resistance element, the power that is inputted into the heater device powers the thermostat.

The thermostat features may allow the heated hose assembly to be completely self-sufficient and self-regulating without the use of a separate control, such as is required in conventional configurations. This self-regulation permits the heated hose assembly to regulate at a specific temperature range based on the requisite application. The heater device further may have options to be controlled using a timer, or switched on and off manually.

The heated hose assembly may have connectors with barbed, swaged, or O-ring style compression. The hose assembly may be open ended, requiring the use of hose clamps, crimp rings, or ferrules to hold the hose assembly in place. The hose assembly may be provided with a display device or other indicator to display information such as life time, maintenance requirements, temperature, thermostat settings, power settings, or any RFID applications. The thermostat, resistance wires, and lead wires may require a splice to be crimped between one another. This splice may be a one-to-one or butt splice. The splice may also include a terminal and electrical connectors. The splices may be protected by a potting of some sort to prevent water ingression. This potting may include adhesive, UV cured material, epoxy, hot melt, or any water resistant material. The protection may also be an adhesive lined heat shrink, injection molded over mold, compression bands or O-rings, or water proof material. To power the heater device of the heated hose assembly, the lead wires may be configured of any terminating size that can fit into a suitable electrical connector.

The heated hose assembly may be constructed with diameter variance in which the tubular member changes diameter along its length. The hose assembly further may be constructed with material variance, where the hose assembly (or one or more components thereof) changes material along its length. The hose assembly further may be convoluted or corrugated (see for example FIG. 1).

An aspect of the invention, therefore, is a heated hose assembly. In exemplary embodiments, the heated hose assembly includes a tubular member, a heater device comprising an electrical resistance element in thermal communication with the tubular member, and a thermal regulating device that controls a flow of electrical current through the heater device based on a sensed temperature of the hose assembly. Heat generated by the heater device when the electrical current flows through the resistance element heats the tubular member.

In an exemplary embodiment of the heated hose assembly, the heater device extends around an outer diameter of the tubular member along an axial length of the tubular member.

In an exemplary embodiment of the heated hose assembly, the heater device is flexible so as to conform to the outer diameter of the tubular member.

In an exemplary embodiment of the heated hose assembly, the heater device has corrugations to provide flexibility to the heater device, wherein the heater device has a flex-fit interaction with the tubular member to secure the heater device to the tubular member.

In an exemplary embodiment of the heated hose assembly, the electrical resistance element comprises heater wires that extend through the heater device.

In an exemplary embodiment of the heated hose assembly, the heater wires spiral along an entire length of the heater device.

In an exemplary embodiment of the heated hose assembly, the heater device comprises heat tape and resistance wires embedded within the heat tape.

In an exemplary embodiment of the heated hose assembly, the heated hose assembly further includes a woven fabric that encapsulates the heat tape.

In an exemplary embodiment of the heated hose assembly, the heated hose assembly further includes end tape that secures an end of the woven fabric to prevent unraveling of the heater device.

In an exemplary embodiment of the heated hose assembly, the woven fabric is pre-formed in a spiral configuration to provide a stretch-fit engagement with an exterior surface of the tubular member.

In an exemplary embodiment of the heated hose assembly, the heated hose assembly further includes a mechanical connection embedded within an end of the woven fabric for connecting the heater device to a support element.

In an exemplary embodiment of the heated hose assembly, the heater device comprises heater wires that are spirally wrapped around the tubular member, and adhesive tape that is applied to the heater wires and tubular member to retain the heater wires in a fixed position against the tubular member.

In an exemplary embodiment of the heated hose assembly, the adhesive tape is applied at regularly spaced intervals along the tubular member.

In an exemplary embodiment of the heated hose assembly, the thermal regulating device is a thermostat that controls the flow of electrical current through the heater device.

In an exemplary embodiment of the heated hose assembly, the thermostat is a bimetallic disc thermostatic.

In an exemplary embodiment of the heated hose assembly, the heated hose assembly further includes lead wires for connecting the heater device to an external power source, and the thermal regulating device is attached in series with one of the lead wires.

In an exemplary embodiment of the heated hose assembly, the thermal regulating device is a temperature coefficient resistance material that is part of the heater device.

In an exemplary embodiment of the heated hose assembly, when the thermal regulating device senses that the hose assembly temperature falls below a first predetermined threshold temperature, the thermal regulating device controls the heater device to permit the flow of current through the heater device; and when the temperature sensor of the thermal regulating device senses that the hose assembly temperature rises above a second predetermined threshold temperature, the thermal regulating device controls the heater device to stop the flow of current through the heater device.

In an exemplary embodiment of the heated hose assembly, the heated hose assembly further includes a jacket that extends over the heater device.

In an exemplary embodiment of the heated hose assembly, the jacket comprises a woven fabric sleeve of heat insulating material.

Another aspect of the invention is a method of controlling a heated hose assembly. In exemplary embodiments, the control method includes the steps of: providing a length of a tubular member; extending a heater device around an outer diameter of the tubular member along an axial length of the tubular member; and connecting a thermal regulating device to the heater device and controlling a flow of current through the heater device based on a sensed hose assembly temperature; wherein heat generated by the heater device when the electrical current flows through the heater device heats the tubular member.

In an exemplary embodiment of the control method, the control method further includes the steps of: when the thermal regulating device senses that the hose assembly temperature falls below a first predetermined threshold temperature, controlling the heater device to permit the flow of current through the heater device; and when the temperature sensor of the thermal regulating device senses that the hose assembly temperature rises above a second predetermined threshold temperature, controlling the heater device to stop the flow of current through the heater device.

In an exemplary embodiment of the control method, the second predetermined threshold temperature is the same as the first predetermined temperature.

In an exemplary embodiment of the control method, the second predetermined threshold temperature is above the first predetermined threshold temperature.

In an exemplary embodiment of the control method, the first and second predetermined threshold temperatures are at least one of an ambient environmental temperature adjacent the hose assembly, or a sensed temperature of the tubular member.

In an exemplary embodiment of the control method, the control method further includes applying an insulating jacket at locations along the tubular member to contain heat adjacent to the tubular member.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A heated hose assembly comprising:
a tubular member;
a heater device comprising an electrical resistance element in thermal communication with the tubular member; and
a thermal regulating device that controls a flow of electrical current through the heater device based on a sensed temperature of the hose assembly;
wherein heat generated by the heater device when the electrical current flows through the resistance element heats the tubular member.

2. The heated hose assembly of claim 1, wherein the heater device extends around an outer diameter of the tubular member along an axial length of the tubular member.

3. The heated hose assembly of claim 2, wherein the heater device is flexible so as to conform to the outer diameter of the tubular member.

4. The heated hose assembly of claim 3, wherein the heater device has corrugations to provide flexibility to the heater device, wherein the heater device has a flex-fit interaction with the tubular member to secure the heater device to the tubular member.

5. The heated hose assembly of any of claims 1-4, wherein the electrical resistance element comprises heater wires that extend through the heater device.

6. The heated hose assembly of claim 5, wherein the heater wires spiral along an entire length of the heater device.

7. The heated hose assembly of claim 1, wherein the heater device comprises heat tape and resistance wires embedded within the heat tape.

8. The heated hose assembly of claim 7, further comprising a woven fabric that encapsulates the heat tape.

9. The heated hose assembly of claim 8, further comprising end tape that secures an end of the woven fabric to prevent unraveling of the heater device.

10. The heated hose assembly of claim 8, wherein the woven fabric is pre-formed in a spiral configuration to provide a stretch-fit engagement with an exterior surface of the tubular member.

11. The heated hose assembly of claim 10, further comprising a mechanical connection embedded within an end of the woven fabric for connecting the heater device to a support element.

12. The heated hose assembly of claim 1, wherein the heater device comprises heater wires that are spirally wrapped around the tubular member, and adhesive tape that is applied to the heater wires and tubular member to retain the heater wires in a fixed position against the tubular member.

13. The heated hose assembly of claim 12, wherein the adhesive tape is applied at regularly spaced intervals along the tubular member.

14. The heated hose assembly of any of claims 1-13, wherein the thermal regulating device is a thermostat that controls the flow of electrical current through the heater device.

15. The heated hose assembly of claim 14, wherein the thermostat is a bimetallic disc thermostatic.

16. The heated hose assembly of any of claims 1-15, further comprising lead wires for connecting the heater device to an external power source, and the thermal regulating device is attached in series with one of the lead wires.

17. The heated hose assembly of any of claims 1-13, wherein the thermal regulating device is a temperature coefficient resistance material that is part of the heater device.

18. The heated hose assembly of any of claims 1-16, wherein:
when the thermal regulating device senses that the hose assembly temperature falls below a first predetermined threshold temperature, the thermal regulating device controls the heater device to permit the flow of current through the heater device; and
when the temperature sensor of the thermal regulating device senses that the hose assembly temperature rises above a second predetermined threshold temperature, the thermal regulating device controls the heater device to stop the flow of current through the heater device.

19. The heated hose assembly of any of claims 1-18, further comprising a jacket that extends over the heater device.

20. The heated hose assembly of claim 19, wherein the jacket comprises a woven fabric sleeve of heat insulating material.

21. A method of controlling a heated hose assembly comprising the steps of:
providing a length of a tubular member,
extending a heater device around an outer diameter of the tubular member along an axial length of the tubular member; and
connecting a thermal regulating device to the heater device and controlling a flow of current through the heater device based on a sensed hose assembly temperature;
wherein heat generated by the heater device when the electrical current flows through the heater device heats the tubular member.

22. The control method of claim 21, further comprising the steps of:
when the thermal regulating device senses that the hose assembly temperature falls below a first predetermined threshold temperature, controlling the heater device to permit the flow of current through the heater device;
and when the temperature sensor of the thermal regulating device senses that the hose assembly temperature rises above a second predetermined threshold temperature, controlling the heater device to stop the flow of current through the heater device.

23. The control method of claim 22, wherein the second predetermined threshold temperature is the same as the first predetermined temperature.

24. The control method of claim 22, wherein the second predetermined threshold temperature is above the first predetermined threshold temperature.

25. The control method of any of claims 22-24, wherein the first and second predetermined threshold temperatures are at least one of an ambient environmental temperature adjacent the hose assembly, or a sensed temperature of the tubular member.

26. The control method of any of claims 21-25, further comprising applying an insulating jacket at locations along the tubular member to contain heat adjacent to the tubular member.
